(19) United States
(12) Patent Application Publication
(10) Pub. No.: US 2013/0125471 A1
(43) Pub. Date: May 23, 2013

(54) Window Components with Toggle Anchors and Windows Incorporating Same

(71) Applicants: Dominick BENEVENGA, North Haledon, NJ (US); Juan Cornejo, East Brunswick, NJ (US); Martin Pezo, Nutley, NJ (US)

(72) Inventors: Dominick BENEVENGA, North Haledon, NJ (US); Juan Cornejo, East Brunswick, NJ (US); Martin Pezo, Nutley, NJ (US)

(21) Appl. No.: 13/299,795

(22) Filed: Nov. 18, 2011

(51) Int. Cl. E06B 3/44; B23P 11/00; F16B 13/12

(52) U.S. Cl. 49/449; 49/506; 411/80.5; 29/525.02

(57) ABSTRACT

A window has a frame and a movable sash mounted within the frame. The sash is formed from interconnected lineals bounding a glazing unit with at least one of the lineals being a sash rail made of a substantially hollow extrusion. A sash lock is mounted to the sash rail by means of a pair of toggle anchors projecting from the sash lock into the sash rail. A corresponding pair of lock screws is driven through the toggle anchors causing them to spread apart within the rail to form a mechanical lock that fixes the sash lock securely to the sash rail. More broadly, a component is anchored to an extrusion, which may be substantially hollow, with toggle anchors extending through holes in the extrusion and being spread apart within the holes by a screw.

### TECHNICAL FIELD

This disclosure relates generally to windows and more particularly to window components such as sash locks and snubbers secured to substantially hollow extruded lineals of windows. The disclosure also relates to components similarly attached to substantially hollow extrusions of doors.

### BACKGROUND

Single and double hung windows have a lower sash that can be opened and closed. A sash lock usually is attached with screws to the top rail of the lower sash and a mating keeper is attached to the bottom rail of the upper sash. When the lower sash is closed, the sash lock and keeper align and the sash lock can be manually manipulated to engage its latch with the keeper and lock the lower sash in its closed position. Other types of windows such as casement and awning windows may have similar locking mechanisms although the sash may hinge open rather than slide open.

Sash locks traditionally have been mounted to a sash rail by means of wood screws driven through holes in the sash lock and into the material of the sash rail. This works well for certain types of window sashes, such as sashes made of wood or solid composite materials. However, for vinyl or composite window sashes made with substantially hollow extruded frame members, screws do not hold sufficiently well in the material of the sash to secure a sash lock reliably in place. Manufactures have generally addressed this problem by inserting or embedding a material such as a metal reinforcing strip inside a sash rail to receive and hold the screws of a sash lock. While this works, it entails additional components, assembly steps, and costs. Other window components such as snubbers and handles have been secured to hollow extruded lineals such as window sash frames in similar ways.

A need exists for window components that can be securely fixed directly to a substantially hollow extruded sash frame or other hollow lineal made of a vinyl or a composite material. Components should be attachable without the need for metal or another reinforcing material inside the sash frame to receive and hold the screws of the sash lock. It is to the provision of window components and also door components that meet this and other needs that the present disclosure is primarily directed.

### SUMMARY

Briefly described, in one embodiment, a sash lock has a body, a latch, and a handle. The body of the sash lock is formed with lock screw holes and integral toggle anchors that depend from the bottom of the sash lock beneath the lock screw holes. The toggle anchors are formed with sets of spreadable wings and are sized to be received in preformed attachment holes in, for example, the substantially hollow upper rail of a vinyl sash. Lock screws can then be driven through the lock screw holes of the sash lock and through the toggle anchors. This causes the wings of the toggle anchors to spread apart within the substantially hollow sash rail. The spreading wings of the toggle anchors form a mechanical lock creating a strong secure engagement between the sash rail and the sash lock. The sash lock is therefore anchored securely in place on the sash rail without the need for an internal reinforcement material for receiving the screws.

In another embodiment, a snubber for use with larger casement and awning windows is formed with similar toggle anchors for attachment to hollow vinyl lineals. More broadly, the invention encompasses components in general that have toggle anchors configured to facilitate attachment of the components to hollow window and door lineals without the need for internal metal strips or other reinforcement.

These and other aspects, features, and advantages of the disclosed window components and methods will become more apparent to the skilled artisan upon review of the detailed description set forth below taken in conjunction with the accompanying drawing figures, which are briefly described as follows.

### BRIEF DESCRIPTION OF THE DRAWINGS

FIG. 1 is a plan view from the inside of a simple double hung vinyl window incorporating a sash lock according to the invention.

FIG. 2 is an exploded perspective view of the top rail of the lower sash of the window of FIG. 1 illustrating installation of the sash lock according to principles of the invention.

FIG. 3 is an enlarged perspective view of the middle portion of the top rail of FIG. 2 illustrating perhaps better the installation of a sash lock according to the invention.

FIG. 4 is an enlarged perspective view of the middle portion of the top rail of FIG. 2 after the sash lock has been fixed to the sash rail according to the invention.

FIG. 5 is an exterior plan view of a sash lock that incorporates principles of the invention in one preferred embodiment.

FIG. 6 is a perspective view from beneath the sash lock of FIG. 5 illustrating in more detail one preferred configuration of the toggle anchors thereof.

FIG. 7 is a partially cross sectional view looking along a hollow check rail showing the spreading and locking of the toggle anchors within the hollow check rail.

FIG. 8 is a perspective view of another window component in the form of a snubber that incorporates principles of this invention.

FIG. 9 is a side elevational view of the snubber of FIG. 8 illustrating in more detail the configuration of the toggle anchors thereof.

### DETAILED DESCRIPTION

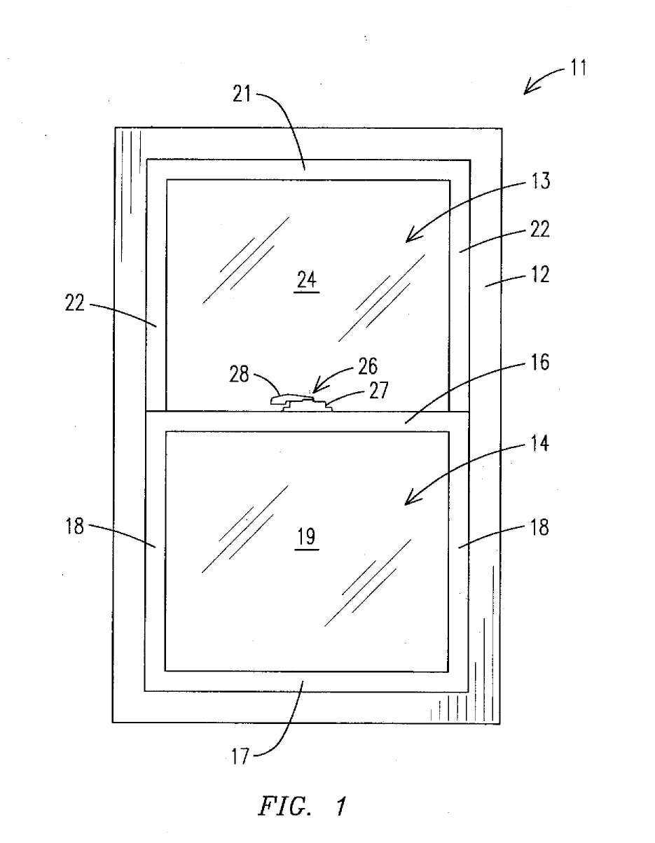

Referring now in more detail to the drawing figures, wherein like reference numerals indicate like parts throughout the several views, FIG. 1 illustrates a simple double (or single) hung window 11 having a frame 12, an upper sash 13, and a lower sash 14. The window 11 is shown as it appears from the interior side of the window; i.e. the side that faces the interior of a dwelling. The lower sash 14 has a top rail 16 (sometimes called a check rail), a bottom rail 17, and vertical stiles 18 that together frame a glass or glazing unit 19. Similarly, the upper sash 13 has a top rail 21, a bottom rail 22 (hidden behind the top rail 16 in FIG. 1), and vertical stiles 22 that together frame a glazing unit 24. At least the lower sash 19 can be raised and lowered within the frame 12 to open and close the window as desired. In the case of double hung windows, both the upper and lower sashes can be raised and lowered.

A sash lock 26 is mounted on a wall of hollow the top rail 16 of the lower sash and includes a base secured to the rail and an articulating handle 28 that can be selectively rotated to extend and retract a latch 29 (FIG. 3). The latch 29, when extended, engages a keeper (not shown) on the bottom rail of the upper sash 13 to lock the two sashes together. The window 11 may be a vinyl window or a composite window in which the rails, stiles, and/or frame are extruded of vinyl or a vinyl composite material and generally are substantially hollow inside. The top rail of the lower sash may be without an internal reinforcement; meaning that it may not contain an internal reinforcing strip or bar made of metal or another material to provide an anchoring substrate for receiving and holding screws. Thus, only the vinyl wall of the hollow rail is available for securing the sash lock 26 to the rail 16.

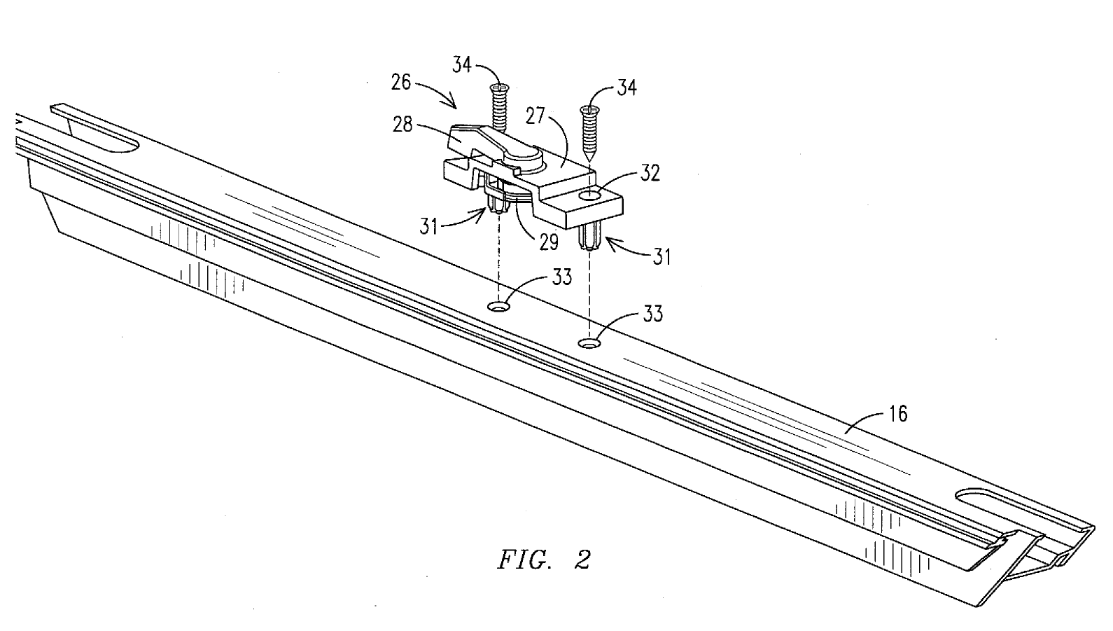

FIGS. 2 and 3 illustrate in more detail the sash lock 26 of the present embodiment and its attachment to rail 16. The sash lock 26 has a body 27, a rotatable handle 28, and a latch 29 that is extended upon rotation of the handle to engage a keeper (not shown). The body 27 of the sash lock 26 is formed with a pair of depending toggle anchors 31 that extend downwardly from lock screw holes 32 formed through the body. The body 27 of the sash lock may be formed of any appropriate material, but preferably is molded of a relatively hard plastic material such as nylon or a polycarbonate. Fillers and/or rigidifiers such as glass fibers may be included to form a composite if desired. The top rail 16 of the lower sash has a pair of holes 33 punched or otherwise formed therethrough and the holes are spaced apart and shaped to receive the toggle anchors 31 of the sash lock 26, as perhaps best illustrated in FIG. 3. The holes 33 are round in the illustrated embodiment, but may be any appropriate shape such as square for example. Further, the holes 33 are sized to receive the toggle anchors 31 in a relatively snug fitting relationship so that the toggle anchors of the sash lock 26 can be pressed into the holes during assembly of a window and then secured as detailed below.

A pair of lock screws 34 are sized and configured to be inserted through the holes 32 in the body 27 of the sash lock and then threaded into and through the depending toggle anchors 31. As described in more detail below, threading the lock screws 34 through the toggle anchors causes the toggle anchors to expand inside a substantially hollow lineal and thereby to lock the body of the sash lock mechanically to the sash rail 16. It has been found that the locking of the toggle anchors within the holes attaches and anchors the sash lock 26 to the sash rail 16 firmly and securely without the need for reinforcement inside the sash rail to receive and hold the screws of the sash lock. The elimination of the internal reinforcement reduces cost, production time, and complexity of a window unit, and thereby may enhance profitability for a manufacturer. As an alternative to screws, other fastening mechanisms such as pop rivets for example may be used so long as the fastening mechanism causes the toggle anchors to expand.

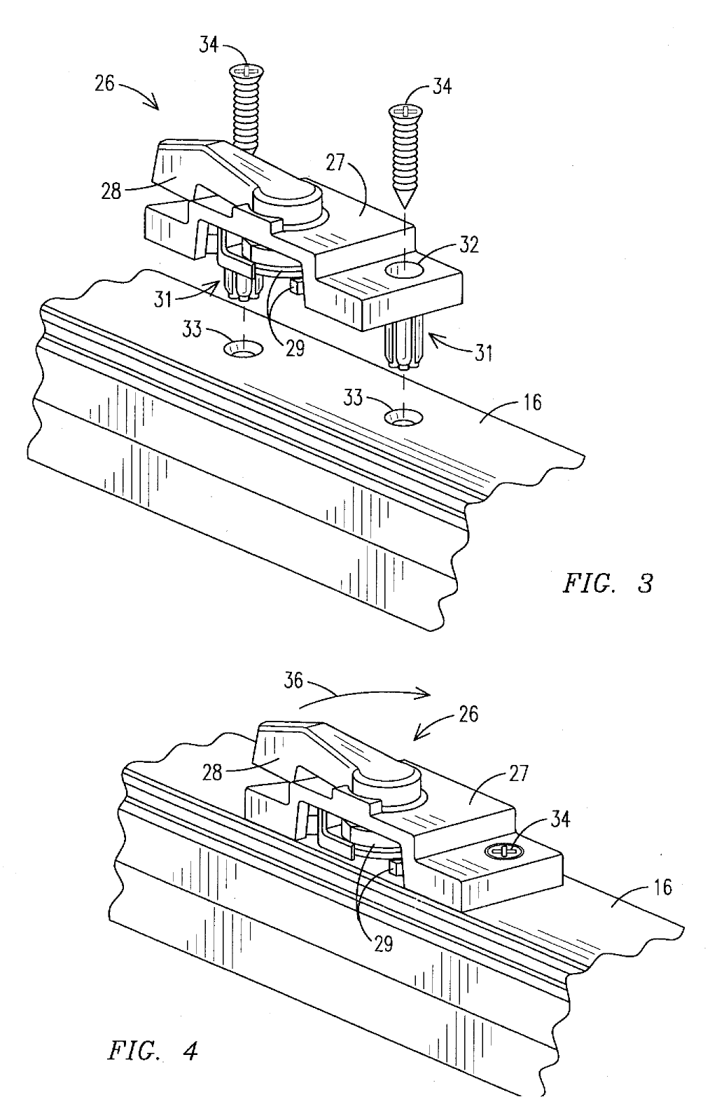

FIG. 4 shows the sash lock 26 of this disclosure after having been attached to the sash rail 16 as described above, and as seen from the exterior side of the window. The body 16 of the sash lock is firmly secured and anchored to the sash rail 16 and the exterior face of the sash lock is substantially aligned with the exterior edge of the sash rail 16. The latch 29 is retracted into the body in its unlocked position; however, upon rotation of the handle in the direction indicated by arrow 36, the latch rotates outwardly to engage with an adjacent keeper (not shown) and thereby lock the upper and lower sashes together in the traditional manner.

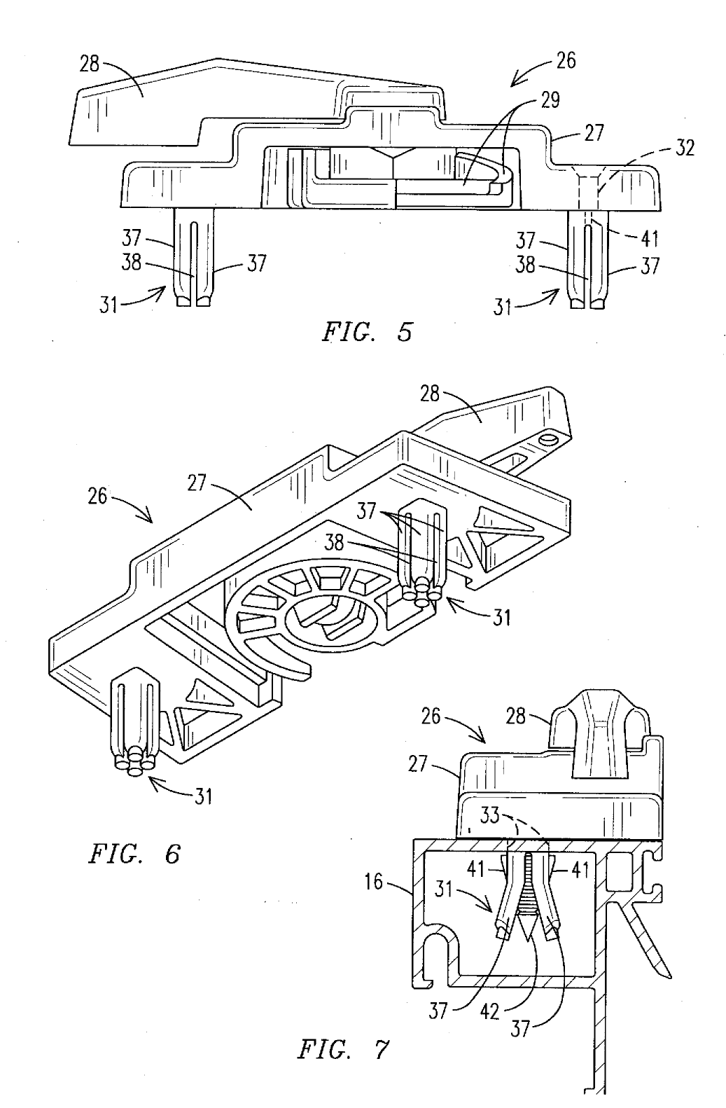

FIGS. 5 and 6 are enlarged views of the sash lock and illustrate better one possible embodiment of the toggle anchors. It will be understood that a myriad of other embodiments are possible within the scope of the invention so long as the toggle anchors are spreadable. Referring to FIGS. 5 and 6, the toggle anchors 31 preferably are unitarily formed with and from the same material as the body 27 of the latch bolt 26 and depend downwardly from the bottom thereof. Each toggle anchor in the illustrated embodiment is configured with four wings 37 that are separated from each other by transverse slots 38. A channel 41 (FIG. 5) extends through the middle of each toggle anchor between the four wings and the channel 41 aligns with the lock screw holes 32 formed through the body 27 of the sash lock 26. The channels 41 are sized smaller than the diameters of the lock screws 34. Accordingly, driving a lock screw 31 through a lock screw hole 32 and through the corresponding channel 41 of a toggle anchor causes the wings 37 of the toggle anchor to spread apart inside a sash rail under the influence of the advancing lock screw. This, in turn, forms a secure mechanical lock between the toggle anchor and the rail without the requirement for metal or other reinforcement inside the sash rail to serve as a substrate for receiving the screw.

FIG. 7 illustrates the just described spreading of the toggle anchors within a hollow sash rail to anchor the sash lock to the rail. The toggle anchors 31 have previously been inserted through corresponding holes 33 in the sash rail so that the toggle anchors reside inside the hollow rail. The anchor screws 42 have been threaded through the toggle anchors and the advancing of the screws is seen to spread out the toggle anchors as shown. The upper portions of the toggle anchors also spread against the walls of the lock screw holes 33 to wedge the toggle anchors firmly in the holes. Further, in the embodiment of FIG. 7, the toggle anchors are formed with locking tabs 41 that project outwardly beneath the lock screw holes 33 thereby mechanically anchoring the toggle anchors within their lock screw holes 33. With the toggle anchors locked and anchored as described, the sash lock 26 is securely fixed to the sash rail 16.

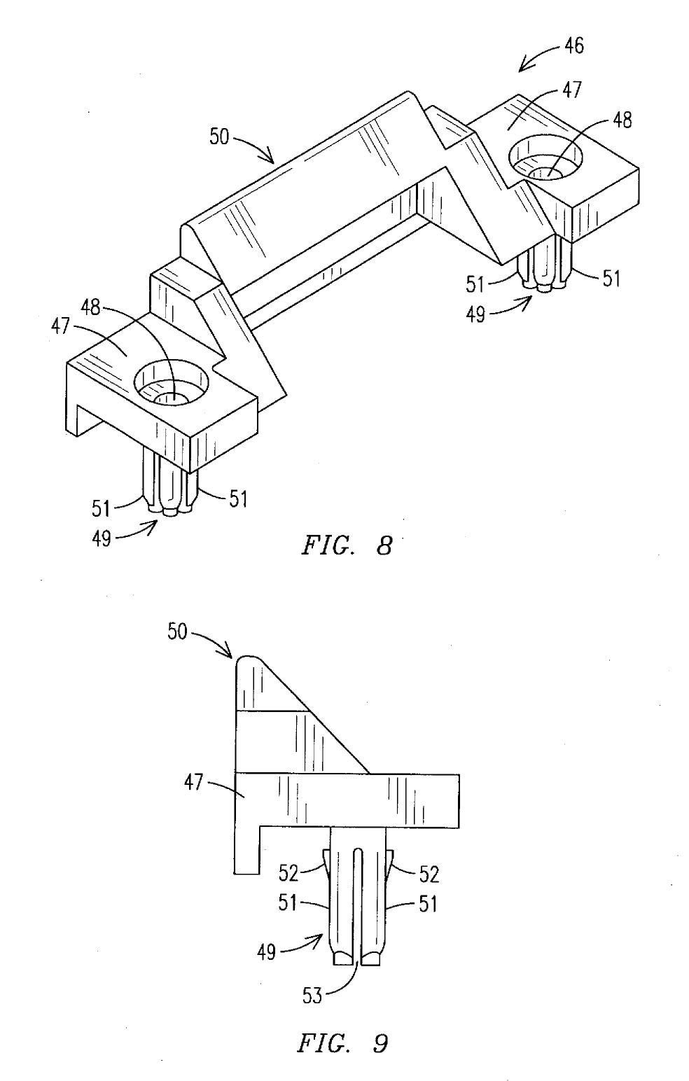

FIG. 8 illustrates another embodiment of a component in the form of a snubber 46 that embodies principles of the invention. Snubbers are used with larger casement and awning windows to draw the mid portions of the sash frames against the window frame when the sash frames are hinged close. In FIG. 8, the snubber 46 includes a base 47 formed with a pair of lock screw holes 48. A toggle anchor 49 depends from the base beneath each of the lock screw holes as in the previously described embodiment. Each of the toggle anchors is formed with wings 51 separated by slots and the wings surround a central channel that is smaller in diameter than the diameter of lock screws to be used to secure the snubber to a sash frame. A snubber latch 50 projects upwardly from the base 47 and is configured to engage with a similar and aligned snubber latch mounted to the frame of a casement or awning window in such a way that the engaging latches draw the sash frame to the window frame as the sash is hinged shut.

FIG. 9 is a side elevational view of the snubber of FIG. 8 showing perhaps better the depending toggle anchors thereof. As with the latch embodiment of FIGS. 6 and 7, the toggle anchors are formed with wings 51 separated by slots 53. The wings are grouped around a central channel that is smaller in diameter than the diameter of an anchor screw to be used in securing the snubber to the hollow frame of a window sash, as detailed above. Locking tabs 52 project outwardly from the wings just beneath the base and these locking tabs wedge themselves around and beneath the preformed hole within which the toggle anchor resides in response to an advancing screw, as detailed above.

It will be understood by those skilled in the art that the two illustrated embodiments, the sash lock and the snubber, are but two examples of a range of window components that might incorporate the anchoring system of the present invention. Indeed, virtually any component that needs to be attached to hollow lineals of a window unit may incorporate the present invention. Such components might include, for example, hinges, operators, openers, handles, keepers, decorative elements, and any other components. Indeed, the invention applies not only to windows, but also to door frames made of hollow lineals or to any item where a component is to be attached to a relatively thin wall of a hollow extrusion. All such variations are to be construed to be within the scope of the present invention.

The invention has been described in terms of preferred embodiments and methodologies considered by the inventors to represent the best modes of carrying out the invention. It will be apparent to those of skill in the art, however, that a wide range of additions, deletions, and modifications may well be made to the exemplary embodiments within the scope of the invention. For instance, the pre-punched holes 33 in the hollow lineal are illustrated as being round. They may, however, take on other shapes such as square, hexagonal, or otherwise to suit a particular need. In such cases, the toggle anchors may be shaped accordingly to be received in the holes. The toggle anchors are illustrated with four spreadable wings, but other configurations with different numbers of spreadable wings or other spreadable features might well be substituted with equivalent results. The window components may be formed from any appropriate material or combination of materials to fit a particular need. While polymeric materials or plastics have been suggested, aluminum or other metals or composite materials such as a polymer/wood fiber composite may be substituted with equivalent results. Some exemplary embodiments are illustrated with locking tabs (52) and some are illustrated without locking tabs. While the locking tabs have been found desirable in some applications to enhance the mechanical lock, locking tabs are not necessarily required and are not a limitation of the invention. Also, while the invention is particularly applicable to substantially hollow extruded lineals, it also may be applied to solid lineals made of wood or other materials. In such cases, the locking features may spread and wedge themselves against the walls of a bore in a solid lineal to hold a component in place with a mechanical lock. These and other additions, deletions, and modifications might well be made to the exemplary embodiments illustrated herein without departing from the spirit and scope of the invention as set forth in the claims.

What is claimed is:

1. A window comprising:
a frame;
a sash having a sash frame with at least one rail, the sash frame surrounding a glazing unit the sash being mounted within the frame for movement between an open position and a closed position;
a sash lock on the at least one rail and having a body and a handle that, when manipulated, extends and retracts a latch from the body;
a pair of toggle anchors on the sash lock extending into the at least one rail, each toggle anchor having spreadable features inside the rail; and
fasteners extending through the toggle anchors, the fasteners urging the spreadable features of the toggle anchors apart to anchor the sash lock mechanically in place on the at least one rail.

2. A window as claimed in claim 1 wherein the at least one rail comprises a polymeric material.

3. A window as claimed in claim 2 wherein polymeric material comprises vinyl and the lineal comprises a substantially hollow interior.

4. A window as claimed in claim 1 wherein the at least one rail is a composite material.

5. A window as claimed in claim 4 wherein the at least one rail is an extruded composite lineal with a substantially hollow interior.

6. A window as claimed in claim 1 wherein the body comprises a plastic material.

7. A window as claimed in claim 6 wherein the plastic material comprises nylon or a polycarbonate.

8. A window as claimed in claim 6 wherein the body further comprises a filler.

9. A window as claimed in claim 1 wherein the spreadable features comprise spreadable wings.

10. A window as claimed in claim 1 wherein the fasteners comprise lock screws.

11. A method of attaching a component to a substantially hollow extrusion having a wall comprising the steps of:
(a) obtaining a component having at least one toggle anchor projecting therefrom;
(b) extending the toggle anchor of the component through an opening in the wall of the hollow extrusion and into the interior of the hollow extrusion; and
(c) causing the toggle anchor to spread apart inside the hollow extrusion to anchor the component mechanically on the wall of the hollow extrusion.

12. The method of claim 11 wherein the hollow extrusion comprises a window component.

13. The method of claim 12 wherein the window component comprises a rail.

14. The method of claim 11 wherein step (c) comprises driving a fastener through the toggle anchor.

15. The method of claim 14 wherein the step of driving a fastener comprises threading a lock screw through the toggle anchor.

16. A component for attachment to a substantially hollow extrusion forming part of a window or door unit, the component comprising a body and at least one toggle anchor projecting from the body and sized to be received within an opening in the substantially hollow extrusion, the toggle anchor being spreadable when a fastener is driven through the toggle anchor to lock the component mechanically to the substantially hollow extrusion.

17. A component as claimed in claim 16 wherein the component comprises a sash lock.

18. A component as claimed in claim 16 wherein the substantially hollow extrusion comprises a sash rail.

19. A component as claimed in claim 18 wherein the component comprises a sash lock.

20. A fenestration unit comprising a frame and a panel mounted in the frame, the panel including at least one substantially hollow lineal having a wall with at least one hole formed in the wall extending into the hollow interior of the lineal, a component mounted on the wall of the hollow lineal, the component including a first portion located on the exterior of the hollow lineal and a second portion extending through the at least one hole, the second portion being at least partially spread apart within the hollow lineal to form a mechanical lock with the at least one hole to anchor the component to the hollow lineal.

21. A fenestration unit as claimed in claim 20 wherein the fenestration unit comprises a window or a door.

22. A fenestration unit as claimed in claim 21 wherein the fenestration unit is a window wherein the panel is a sash.

23. A fenestration unit as claimed in claim 22 wherein the component is a latch or a snubber.

24. A fenestration unit as claimed in claim 21 and further comprising a screw extending through the second portion with the screw maintaining the second portion in its spread apart configuration.

25. A fenestration unit as claimed in claim 21 wherein the second portion comprises a toggle anchor.
